(19) United States
(12) Patent Application Publication
(10) Pub. No.: US 2018/0005248 A1
(43) Pub. Date: Jan. 4, 2018

(54) PRODUCT, OPERATING SYSTEM AND TOPIC BASED

(71) Applicant: Hewlett-Packard Development Company, L.P., Fort Collins, CO (US)

(72) Inventor: Georgia Koutrika, Palo Alto, CA (US)

(21) Appl. No.: 15/545,687

(22) PCT Filed: Jan. 30, 2015
(86) PCT No.: PCT/US2015/013714

§ 371 Date: Jul. 22, 2017

(51) Int. Cl. G06Q 30/00; G06F 17/30; G06F 7/02; G06N 99/00

(52) U.S. Cl. CPC G06Q 30/016; G06N 99/005; G06F 17/30528; G06F 7/026; G06F 7/02

(57) ABSTRACT

A method is described in which a topic similarity score, a product similarity score and an operating system similarity score between an original post and each one of a plurality of previous posts are determined; an overall similarity score of the each one of the plurality of previous posts based on the topic similarity score, the product similarity score and the operating system similarity score is determined; and a recommendation of a top K number of the plurality of previous posts based on the overall similarity score of the each one of the plurality of previous posts is sent to a display device.

### BACKGROUND

Online product discussion services comprise a communication channel with and among customers on a company's products. In these sites, the customers ask questions about a company's product to seek solutions to problems with products. Various people can answer the questions creating a valuable repository of information about the company's products. Unfortunately, when a customer visits the forum, finding the right information may be tedious and often an unsuccessful process.

### BRIEF DESCRIPTION OF THE DRAWINGS

FIG. 1 is a block diagram of an example system of the present disclosure;

FIG. 2 is an example of an original post and recommendations based on the original post;

FIG. 3 is an example flowchart of a method for providing product aware, operating system aware and topic based recommendations;

FIG. 4 is another example flowchart of a method for providing product aware, operating system aware and topic based recommendations; and

FIG. 5 is an example high-level block diagram of a computer suitable for use in performing the functions described herein.

### DETAILED DESCRIPTION

The present disclosure broadly discloses a method and non-transitory computer-readable medium for providing product aware, operating system aware and topic based recommendations. As discussed above, finding the right information within an online product discussion service for a company's product can be a tedious and often an unsuccessful process for the customer. Basic keyword searching does not help because people can describe a problem or refer to a product in different ways. As a result, locating and bringing together the relevant information within a few clicks in these forums can be difficult or the amount of search results based on a basic keyword search can be overwhelming for the customer to manually sift through them.

Examples of the present disclosure provide a novel method for providing product aware, operating system aware and topic based recommendations. For example, based on a question posted by a customer to an online product forum, or discussion service, the customer's question can be analyzed across several dimensions to provide high value recommendations to the customer. In one example, the question can be analyzed along the dimensions of topic, products and operating system. Based on the identified topic, product and operating system of the customer's environment, the examples of the present disclosure can provide a more accurate recommendation of previous posts within the online product forum service that answers the customers question.

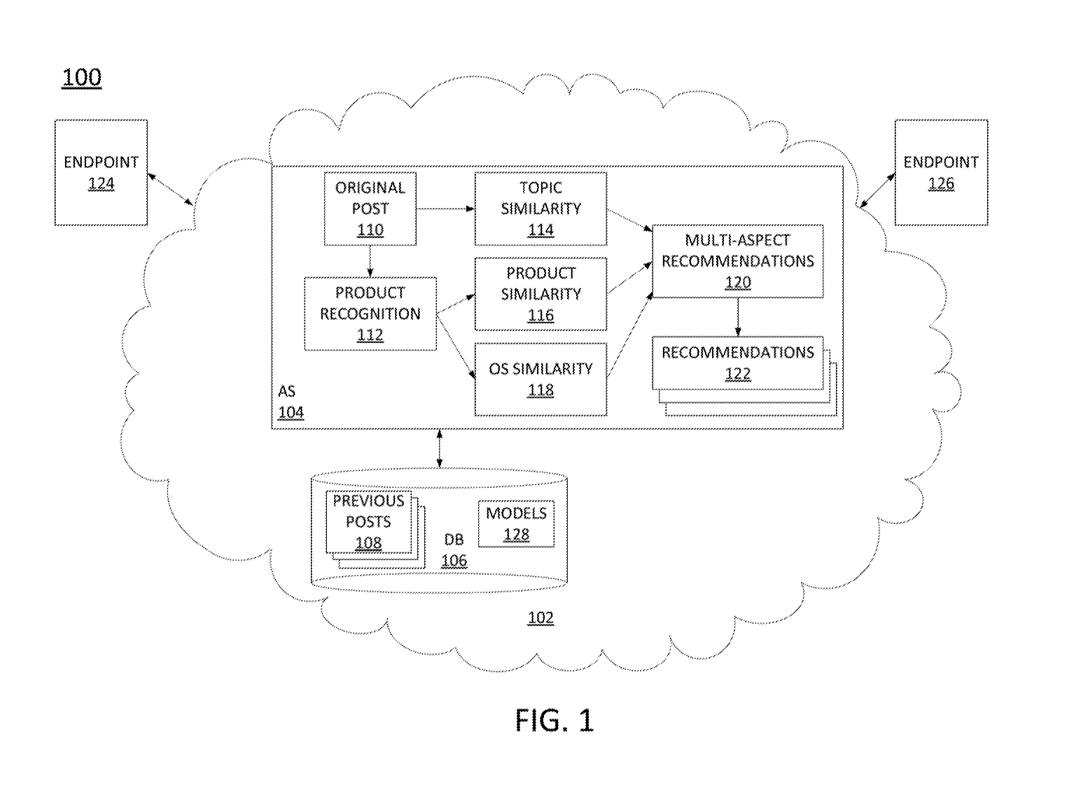

FIG. 1 illustrates an example system 100 of the present disclosure. In one implementation, the system 100 includes a communication network 102 in communication with one or more endpoint devices 124 and 128. It should be noted that although two endpoint devices 124 and 126 are illustrated in FIG. 1 that any number of endpoint devices may be deployed. In one example, the end point devices 124 and 126 may be any type of endpoint device, including for example, a desktop computer, a laptop computer, a mobile telephone, a smart phone, a tablet computer, and the like.

In one example, customers may use their respective endpoint device 124 or 126 to post questions about a company's product or post answers to questions posted about the company's product. The endpoint devices 124 and 126 may be in communication with the communication network 102 that includes an application server (AS) 104 and a database (OB) 106. It should be noted that the communication network 102 has been simplified for ease of explaining examples of the present disclosure. The communication network 102 may include additional network elements (not shown) such as a border element, gateways, firewalls, additional access networks, and the like.

In one example, previous posts 108 containing answers to previously posted questions are stored in the DB 106. In addition, the DB 106 may store one or more models 128 used for identifying topics, products and operating systems (OS) contained in an original post 110 from a customer.

In one example, hand coded rules or models learnt from annotated data may be used to create a product recognition model and an OS recognition model for product recognition and OS recognition, respectively. In one example, the product recognition model and the OS recognition model may be referred to collectively as the product recognition model as the recognition of the OS may be a special case of product recognition. For example, annotated data may be a training set of posts that have been identified with positive and negative matches of products or OS that are marked. Then a classification model can be trained to identify products or OS in the original post 110.

In one implementation, a Latent Dirichlet Allocation (LDA) with Gibbs sampling may be used to create a model for topic recognition. For example, a number of s topics to be generated are given as an input to the algorithm based on a training document set. A small number of topics could provide a broad overview of the document structure, whereas a large number of topics could provide fine-grained topics at the cost of additional computational time.

In one implementation, the AS 104 and the DB 106 may be operated and maintained by a company that produces one or more products that the customers have questions about. In one example, the AS 104 may be deployed as a computer that includes a processor and is modified to perform the dedicated functions described herein. For example, the processor may execute the instructions and algorithms provided by the modules within the AS 104 as described below.

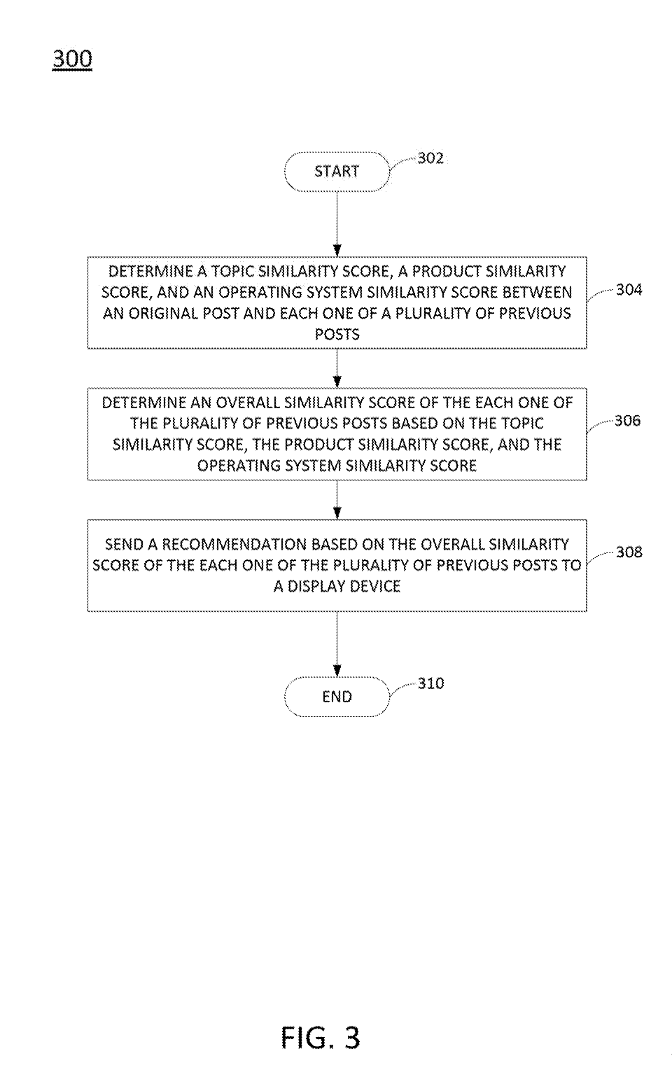

In one example, the AS 104 may receive the original post 110 from the endpoint device 124 or 128 of the customers. The AS 104 may process the original post 110 to provide one or more recommendations 122 back to the endpoint device 124 or 128 that submitted the original post 110. In one example, the recommendations 122 may include one or more of the previous posts 108 based on an overall similarity score that is determined or calculated by a processor (e.g., the processor 302 described below and illustrated in FIG. 3), as discussed in further detail below. In one example, the recommendations 122 may include the top k recommendations based on the top k previous posts 108 that have the highest overall similarity scores.

In one example, to determine the overall similarity score, a product recognition module 112 may analyze the original post 110. The product recognition module 112 may apply the product recognition model and the OS recognition model 128 stored in the DB 106 to identify a product and an OS contained in the original post 110. The identified product may be received by a product similarity module 116 and the identified OS may be received by an OS similarity module 118. A topic similarity module 114 may receive the original post 110.

In one example, the topic similarity module 114 may include instructions for the processor to determine a topic similarity score between the original post 110 and the previous posts 108 stored in the DB 106. In one example, using latent topic models, a thread dᵢ can be represented by a set of estimated latent topic probabilities P(zⱼ|dᵢ) over the set of different topics zⱼ in Z. Given a collection D of n threads and s topics, one can denote F_{n×s} the document-topic matrix that captures how the s topics are assigned to the n threads in D. That is Fᵢⱼ=P(zⱼ|dᵢ) with i<=n and j<=x. Given a set of estimated latent topic probabilities for each thread, there are several measures that can be used to compare the similarity of two threads such as the cosine similarity, the unnormalized dot product and the symmetric Kullback-Leibler divergence measure. For example, a processor may communicate with the DB 106 to retrieve and execute a function to calculate the cosine similarity of two threads based on their topics. One example of a cosine similarity function that can be executed by the processor may be shown below:

$$cossim ( {d}_{i} , {d}_{j} ) = \frac{\overline{{F}_{i}} \cdot \overline{{F}_{j}}}{‖ \overline{{F}_{i}} ‖ ‖ \overline{{F}_{j}} ‖} .$$

In one example, a bagging model may be applied to the topic modeling used to determine the topic similarity score to provide a more accurate topic similarity score. One problem with general topic modeling algorithms is that these algorithms only guarantee to converge to a locally optimal maximum likelihood solution and not the globally optimal solution. Thus, different initializations of a topic model will yield different final models. Consequently, document relationships will vary among these models. To tackle this problem and capture document relationships as accurately as possible, a bagging method can be used.

In one example, the bagging method runs the topic model a number of times over the input set of documents and evidence of the similarity of a pair of documents are combined from all the outputs. When using the bagging technique, the bagging method begins by assuming that N different latent topic models M₁ through M_{N} are trained from N different random model initializations. From each model Mₖ, an estimate of the topic distribution is produced for each thread. Once the topic models are generated, an aggregation step follows where for each pair of threads dᵢ and dⱼ the non-zero thread similarity measures between the threads produced by each of the N models are averaged. In one example of the present disclosure, a processor may communicate with the DB 106 to retrieve and execute a function to perform the bagging method. In one example, the bagging method uses an arithmetic mean as described by the function below:

$${sim}_{T} ( {d}_{i} , {d}_{j} ) = \frac{1}{{N}^{′}} {\sum }_{k = 1}^{N} cossim ( {d}_{i} , {d}_{j} , {M}_{k} )$$

where N′≦N is the number of non-zero topic similarity scores for the pair of documents dᵢ and dⱼ.

In one example, the product similarity module 116 may include instructions for the processor to determine a product similarity score between the product identified in the original post 110 and the products in the previous posts 108. The OS similarity module 118 may determine an OS similarity score between the OS identified in the original post 110 and the OS in the previous posts 108. In one example, the processor may determine the product similarity score and the OS similarity score using the same algorithms.

Determining the product similarity score and the OS similarity score may not be straightforward. For example, a post may talk about a single product, but the author may refer to this product several times in the thread in different ways. In another example, the post may talk about more than one product (e.g., “We are currently running HP Officejet 6500 printers in our office and we also have one HP LaserJet 2605n.”). In yet another example, authors in different posts may make different references to the same product.

In addition, different products within a same family may be mentioned in different posts. The product similarity score and the OS similarity score should account for similarity between the products in the same family or series. For example, all deskjet printers are more similar to each other than to laserjet printers.

To account for the factors described above, a processor may need to apply one or more algorithms to determine the product similarity score and the OS similarity score may involve applying one or more algorithms. In one example, two algorithms may be used to determine the product similarity score and the OS similarity score. An objective of the first algorithm is to find whether two strings refer to the same product, but vary slightly due to a typo, a different user writing style, or because the products are close “relatives” in a product family. In one example, a Levenshtein distance may be used as the first algorithm.

In one example, the Levenshtein distance is a string metric for measuring the difference between two strings. For example, the Levenshtein distance is the minimum number of single-character edits (e.g., insertions, deletions or substitutions) required to change one string into the other string.

In one example, the Levenshtein distance is modified to take into account a length of the two strings. For example, the smaller the two strings are, the fewer differences that are acceptable. Conversely, the longer the two strings are, the larger the amount of difference that is acceptable.

To illustrate by example, the string “officejet 6500” and “officejet 5500” should have a high product similarity score because there is enough information to say that these products are quite similar. They are in the same family of “officejet” printers and only have a single character difference. On the other hand, the string “hp6500” and “hp5500” will have a lower score. Although the two strings “hp6500” and “hp5500” also only have a single character difference, the strings are shorter and contain less information. For example, the two strings do not contain enough information to determine if the products are within the same family. For example, “hp6500” could refer to a laserjet printer and “hp5500” could refer to a laptop computer.

In one example, given two product strings sᵢ and sⱼ with sizes or lengths len(sᵢ) and len(sⱼ) respectively, let I=min(len(sᵢ); len(sⱼ)) and lev(sᵢ, sⱼ) be their Levenshtein distance. In one example, a processor may communicate with the DB 106 to retrieve and execute a normalized Levenshtein distance to compute the similarity between the two product strings. An example of the normalized Levenshtein distance may be as follows:

$$normlev ( {s}_{i} , {s}_{j} ) = \{ \begin{matrix}\frac{l - lev ( {s}_{i} , {s}_{j} )}{l + lev ( {s}_{i} , {s}_{j} )} & if lev ( {s}_{i} , {s}_{j} ) > l / 2 \\ \frac{l - lev ( {s}_{i} , {s}_{j} )}{l} & otherwise\end{matrix} .$$

The test lev(sᵢ, sⱼ)>l/2 determines when too many edits are required in order to transform one string to the other. This test may be used as a criterion, which has the meaning that if the number of changes would affect more than half of a string, then one should penalize the final score. This threshold works well for our product similarity computation problem. The threshold value may be set to a different value depending on the domain and the application. Using the example strings above and the normalized Levenshtein distance, the strings “hp6500” and “hp5500” would have a product similarity score of 0.83, while the strings “officejet 6500” and “officejet 5500” would have a product similarity score of 0.923.

As noted above, determining the product similarity score and the OS similarity score may involve applying one or more algorithms. The objective of a second algorithm is to identify when two strings that differ substantially actually refer to the same product. For example, the strings “hp officejet 6310” and the string “6310” would have a low score based on the normalized Levenshtein distance function alone (e.g., 0.15). For example, the two strings are relatively short and have a large number of character differences between the two strings. However, the second algorithm would provide a higher score indicating that the two strings may refer to the same product because of the use of the same model number.

In one example, the second algorithm may be a Jaccard similarity function. In one example, the Jaccard similarity function may be right ordered (e.g., r-ordjacc). The Jaccard index measures the size of the intersection of the two sets divided by the size of their union. The ordered Jaccard similarly takes into account the position of elements in the two strings as well as the length of each element. There are two possibilities when considering the position of elements in two strings. The function may give more importance to larger elements in top positions that coincide resulting in a higher similarity score (e.g., this is called a left-ordered Jaccard). For example, applied to products, products of the same family with different model information would have a higher score using the Jaccard similarity function than products of different families with similar model information. Another possibility when considering the position of the elements of the two strings is to have the function give more importance to larger elements in bottom positions that coincide resulting in a higher similarity score (this is called the right-ordered Jaccard).

In one example, the left-ordered Jaccard index function is described as follows. A string sᵢ (e.g., a product description) can be represented as an ordered set Sᵢ of tokens such that Sᵢ[k] is the k-th token in sᵢ, nⱼ is the number of tokens in sᵢ and hence the size of Sᵢ. Furthermore, len(Sᵢ[k]) is the length of the token Sᵢ[k]. Given two strings sᵢ and sⱼ, their respective ordered sets are Sᵢ and Sⱼ with nᵢ and nⱼ being their corresponding sizes. Sets may have different sizes. Let n=max(nᵢ, nⱼ). To compute the left-ordered Jaccard similarity, one may ‘left-align’ the two sets by ‘padding’ the smaller set with empty tokens at its end. Then, the left-ordered Jaccard similarity returns the product similarity score giving priority to the left positions in the strings. In one example, the left-ordered Jaccard index function may be stored in the DB 106 and retrieved and executed by a processor. In one example, the left-ordered Jaccard index function may be expressed as follows:

$$l = ordjacc ( {S}_{i} , {S}_{j} ) = \frac{{\sum }_{k = 1 , n}^{ } {w}_{k} * 1 / k * ( len ( {S}_{i} \vert k \vert ) + len ( {S}_{j} \vert k \vert ) )}{{\sum }_{k = 1 , n}^{ } 1 / k * ( len ( {S}_{i} \vert k \vert ) + len ( {S}_{j} \vert k \vert ) )}$$

where wₖ=1 if Sᵢ|k|==sⱼ|k| and wₖ=0 otherwise.

The left-ordered Jaccard index function can be also expressed in a form that gives priority to the last positions. In this case, the Jaccard similarity would right-align sᵢ and sⱼ and pad the smaller set at the left positions. The right-ordered Jaccard similarity is denoted r-ordjacc. Using the r-ordjacc based on the left-ordered Jaccard index function described above for the example strings above, the similarity score of the “hp officejet 6310” and “6310” would only be 0.15 using normlev of normalized Levenshtein distance, but would be 0.42 with the r-ordjacc.

In one example, combining together the scores determined from Levenshtein distance and the left-ordered Jaccard index function, a processor may then compute the similarity of two products sₓ and s_{y} by applying a combination of the functions as shown below:

sim(sₓ,x_{y})=max(normlev(sₓ,s_{y}),r−ordjacc(sₓ,s_{y}))

That is, the similarity of the two products is the maximum of the partial similarity scores of the products computed by the different algorithms. A different combining function could also be used, such as the minimum or average.

A processor may compute the similarity of two posts or threads dᵢ and dⱼ based on the lists Pᵢ and Pⱼ of products mentioned in the posts or threads by applying a function below:

sim_{P}(dᵢ,dⱼ)=max{sim(sₓ,s_{y})|∀sₓεPᵢ,∀s_{y}εPⱼ}

where sim(sₓ,s_{y})=max(normlev(sₓ,s_{y}), r−ordjacc(sₓ,s_{y})).

That is the similarity of the two posts is computed by considering the maximum similarity of the products mentioned in the two posts. A different combining function could be also used that computes the similarity of the two posts by considering for example the minimum or average similarity of their product lists. Similarly, a processor may compute the OS similarity score as sim_{OS}(dᵢ, dⱼ) using the normalized Levenshtein distance function, the left or right ordered Jaccard index function and the combination of functions as described above.

After the topic similarity score, the product similarity score and the OS similarity score are each determined, each score will produce a different ranking list of recommendations for previous posts 108 with respect to the original post. However, the different ranking lists may not coincide with one another. For example, the original post 110 and a previous post 108 may have a high topic similarity score referring to the same topic, but may not refer to the same product and have a low product similarity score. In another example, the original post 110 and a previous post may have high OS similarity score, but may refer to different problems and have a low topic similarity score.

As a result, the topic similarity score, the product similarity score and the OS similarity score may be fed to a multi-aspect recommendation module 120. The multi-aspect recommendation module 120 may include instructions for the processor to determine the top k recommendations. In one example, the top k recommendations may be based on an overall similarity score determined by the multi-aspect recommendation module 120. In one example, the overall similarity score may be based on the topic similarity score, the product similarity score and the OS similarity score. In one example, the topic similarity score, the product similarity score and the OS similarity score can each be weighted and summed to obtain the overall similarity score. In one example, a processor may communicate with the DB 106 to retrieve and execute a function to calculate the overall similarity score. In one implementation, the processor may calculate the overall similarity score using a function as described below:

s=a₁*sim_{T}+a₂*sim_{P}+a₃*sim_{OS},

where a₁, a₂ and a₃ are different weights (e.g., a value between 0 and 1) for the topic similarity score sim_{T}, the product similarity score sim_{P} and the OS similarity score sim_{OS}.

In another example, the top k recommendations may be based on other score methods that use the topic similarity score, the product similarity score and the OS similarity score. For example, the top k recommendations may be based on the topic similarity score and then re-ordered based on a combination of the product similarity score and the OS similarity score.

Thus, after all of the scores s are determined for each one of the previous posts 108, the top k previous posts 108 can be filtered and selected as the top k recommendations. The top k recommendations may be sent to a display device of the customer that submitted the original post 110. For example, the display device may be part of the endpoint device 124 or 126 (e.g., a monitor). In one example, if the original post 110 included multiple products or operating systems, the overall similarity score may be determined for each product and OS identified in the original post 110.

In one example, the topic similarity scores, the product similarity scores, the operating system similarity scores and overall similarity scores may be pre-determined between the plurality of previous posts and stored in the DB 106. In one example, the original post 110 may be one of the plurality of previous posts selected by the user. As a result, the topic similarity scores, the product similarity scores, the operating system similarity scores and overall similarity scores may be pre-determined as noted above and the top k recommendations may be quickly provided to the user.

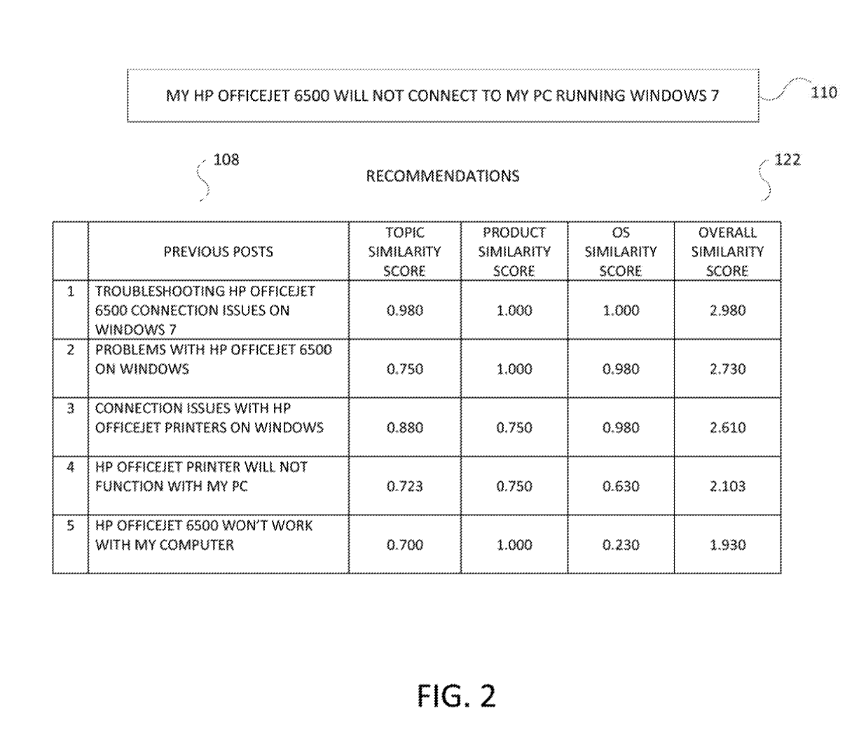

FIG. 2 illustrates an example of an original post 110 and recommendations 122 of previous posts 108 based on an overall similarity score that assumes an equal weighting for each one of the topic similarity score, the product similarity score and the OS similarity score. For example, the original post 110 may be “my HP OfficeJet 6500 will not connect to my PC running Windows 7”. A first previous post 108 may be “troubleshooting HP OfficeJet 6500 connection issues on Windows 7” may have a highest overall similarity score of 2.980. For example, the topic similarity score for the first previous post 108 may be determined to be 0.980 as both the first previous post 108 have a similar topic of connection issues. The product similarity score may be a perfect 1.000 as the product is an exact match of “HP OfficeJet 6500” and the OS similarity score may be a perfect 1.000 as the OS is an exact match of “Windows 7.”

Similarly, the second previous post 108 may be “problems with HP Office Jet 6500 on Windows” and have an overall similarity score of 2.730. The topic similarity score for the second previous post 108 may be determined to be 0.750. Both are related to a problem but the second previous post 108 is more general to problems than a specific connection issue. The product similarity score may be a perfect 1.000 as the product is an exact match of “HP OfficeJet 6500”. The OS similarity score may be determined to be 0.980 as the OS is identified generally as “Windows” in the second previous post 108, rather than specifically “Windows 7” identified in the original post 110.

The overall similarity scores tor the third, fourth and fifth previous posts 108 may be calculated in a similar way. In the example illustrated in FIG. 2, the recommendations may be provided based on a descending order of the overall similarity score. It should be noted that although five recommendations are illustrated in FIG. 2 any number of recommendations may be provided (e.g., one or more).

As a result, examples of the present disclosure provide product aware, OS aware and topic based recommendations to customers in response to questions posted by the customer in an online product discussion or forum service. The examples of the present disclosure provide previous posts to the customer to answer the question of the customer that accurately addresses the topic, the product and the OS contained in the customer's question.

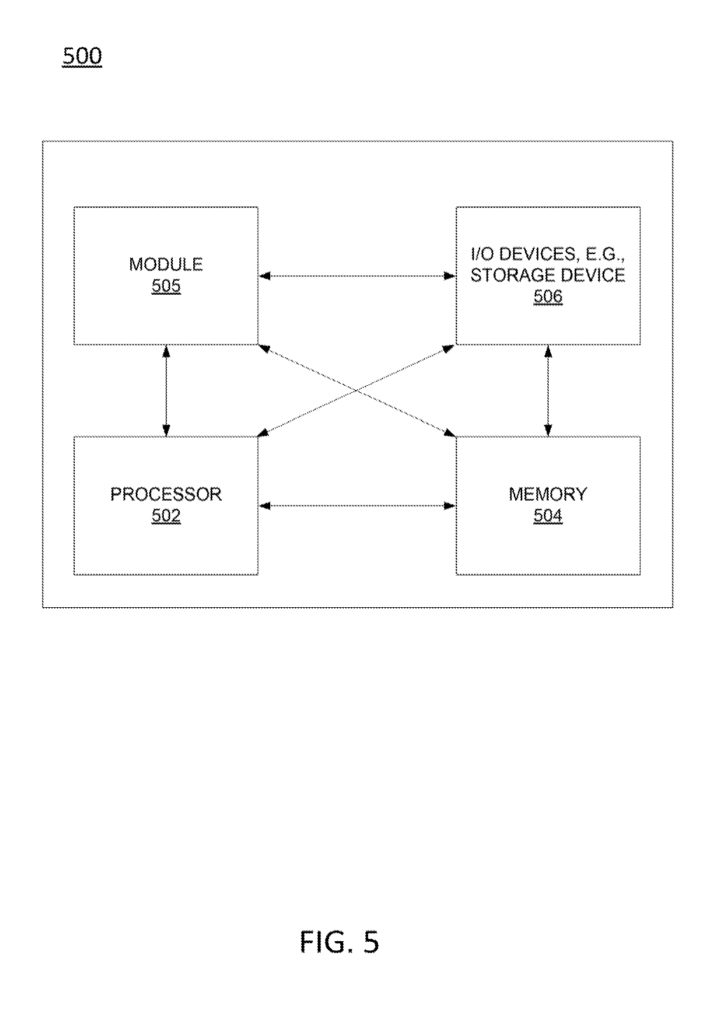

FIG. 3 illustrates a flowchart of a method 300 for providing product aware, operating system aware and topic based recommendations. In one implementation, the method 300 may be performed by the AS 104 or a computer as illustrated in FIG. 5 and discussed below.

At block 302, the method 300 begins. At block 304, the method 300 determines a topic similarity score, a product similarity score and an operating system similarity score between an original post and each one of a plurality of previous posts. For example, a processor may identify a topic, a product and an operating system in the original post based on pre-established models. Based on the topic, the product and the operating system that is identified, the processor may compare the topic, the product and the operating system to a topic, a product and an operating system identified in each one of the plurality of previous posts.

At block 306, the method 300 determines an overall similarity score of the each one of the plurality of previous posts based on the topic similarity score, the product similarity score and the operating system similarity score. In one implementation, the processor may sum the topic similarity score, the product similarity score and the operating system similarity score to determine the overall similarity score, in another implementation, a weight may be applied to the topic similarity score, the product similarity score and the operating system similarity score.

At block 308, the method 300 sends a recommendation based on the overall similarity score of the each one of the plurality of previous posts to a display device. For example, the recommendations may include a top k number of previous posts based on the overall similarity scores. At block 310, the method 300 ends.

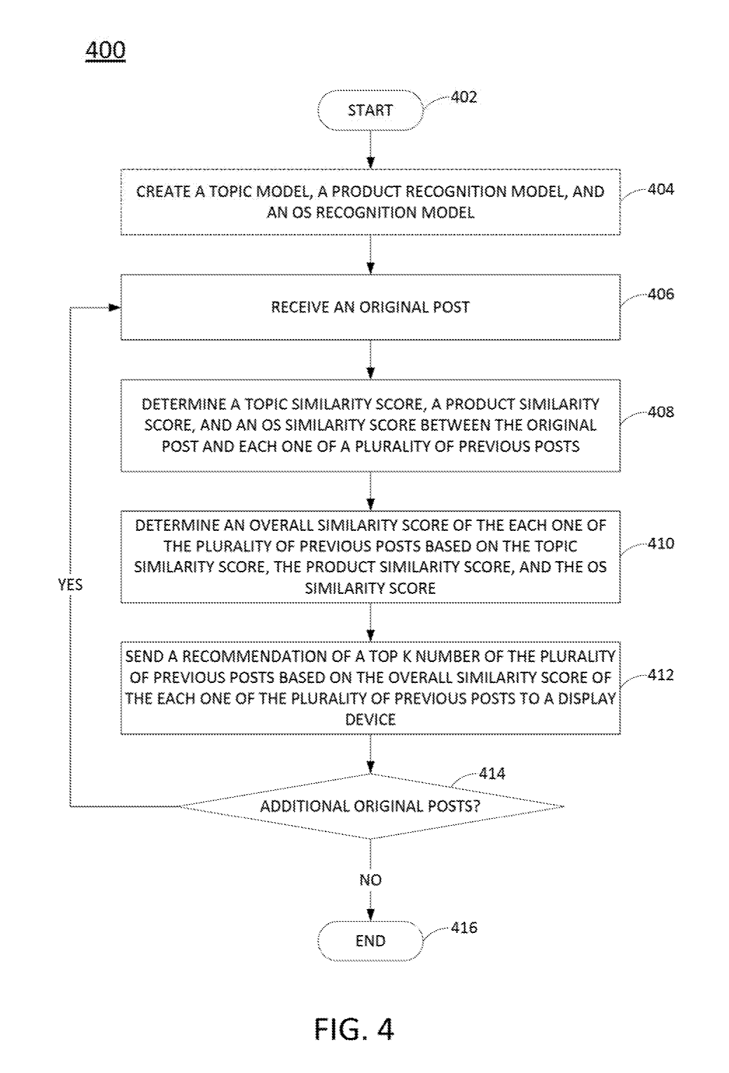

FIG. 4 illustrates a flowchart of a method 400 for providing product aware, operating system aware and topic based recommendations. In one example, the method 400 may be performed by the AS 104 or a computer as illustrated in FIG. 5 and discussed below.

At block 402 the method 400 begins. At optional block 404, the method 400 creates a topic model, a product recognition model and an OS recognition model. In one example, the models may be created using the methods described above. In another example, the models may be obtained from third parties that have created the topic model, the product recognition model and the OS recognition model externally.

At block 408, the method 400 receives an original post. For example, the original post may be a new post to an online product discussion service or forum that includes a question about a company's product. The service or forum may be operated and maintained by the company that produces the product or products to provide quick answers to questions that customers may have. The forum may allow a user to write a post that includes a question about a product and operating system. The post may then be processed to identify a topic, the product and the operating system.

For example, the user may post on the forum “what does XYZ error message mean on my HP 6150 laptop running OS version 8?” The topic may be identified as “XYZ error message,” the product may be identified as “HP 6150 laptop,” and the OS may be identified as “OS version 8.” The identified topic, product and OS may then be used to determine similarity scores between the original post and each one of the previous posts stored in a database. For example, a similar previous post would most likely have answers already posted that would help the customer with the same problem.

At block 408, the method 400 determines a topic similarity score, a product similarity score, and an OS similarity score between the original post and each one of a plurality of previous posts. In one example, the topic similarity score may be determined using a cosine similarity score determined using the cosine similarity function and a bagging method described above. In one example, the product similarity score and the OS similarity score may be determined using a combination of a Levenshtein distance and a Jaccard index using the normalized Levenshtein distance function, the left or right ordered Jaccard index function and the combination of functions as described above.

At block 410, the method 400 determines an overall similarity score of the each one of the plurality of previous posts based on the topic similarity score, the product similarity score and the OS similarity score. In one example, the overall similarity score may be a weighted sum of the topic similarity score, the product similarity score and the OS similarity score. In one example, the overall similarity score may be determined using the function to calculate the overall similarity score described above.

At block 412, the method 400 sends a recommendation of a top k number of the plurality of previous posts based on the overall similarity score of the each one of the plurality of previous posts to a display device. For example, the top k recommendations may be sent to an endpoint device of the customer having a monitor or display. The customer or user may then review the top k recommendations of the previous posts on his or her endpoint device.

At block 414, the method 400 determines if there are any additional original posts. For example, if the customer submits another original post or the original post contained multiple products, the method 400 may return to block 408. The method 400 may then repeat blocks 406-414.

However, if there are no additional original posts, the method 400 may proceed to block 416. At block 416, the method 400 ends.

As a result, the examples of the present disclosure improve the functioning of an application server or a computer. For example, the AS 104 may provide more accurate recommendations of previous posts in response to an original post by a customer based on a product, OS and topic identified in the original post that could not otherwise be verified without the improvements provided by the present disclosure. In other words, the technological art of matching previous posts to an original post is improved by providing a computer that is modified with the ability to provide accurate recommendations based on the product, the OS and the topic contained in the previous posts and the original post, as disclosed by the present disclosure.

It should be noted that although not explicitly specified, one or more blocks, functions, or operations of the methods 300 and 400 described above may include a storing, displaying and/or outputting step as required for a particular application. In other words, any data, records, fields, and/or intermediate results discussed in the methods can be stored, displayed, and/or outputted to another device as required for a particular application. Furthermore, blocks, functions, or operations in FIGS. 3 and 4 that recite a determining operation, or involve a decision, do not necessarily require that both branches of the determining operation be practiced. In other words, one of the branches of the determining operation can be deemed as an optional step.

FIG. 5 depicts a high-level block diagram of a computer that can he transformed to into a machine that is dedicated to perform the functions described herein. Notably, no computer or machine currently exists that performs the functions as described herein. As a result, the examples of the present disclosure improve the operation and functioning of the computer to validate a hard disk drive, as disclosed herein.

As depicted in FIG. 5, the computer 500 comprises a hardware processor element 502, e.g., a central processing unit (CPU), a microprocessor, or a multi-core processor, a memory or storage 504, e.g., random access memory (RAM) and/or read only memory (ROM), a module 505 for providing product aware, operating system aware and topic based recommendations, and various input/output user interface devices 508 to receive input from a user and present information to the user in human perceptible form, e.g., storage devices, including but not limited to, a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like. Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the blocks of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

If should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the blocks, functions and/or operations of the above disclosed methods. In one example, instructions and data for the present module or process 505 for providing product aware, operating system aware and topic based recommendations, e.g., machine readable instructions can be loaded into memory 504 and executed by hardware processor element 502 to implement the blocks, functions or operations as discussed above in connection with the exemplary methods 300 and 400. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 505 for providing product aware, operating system aware and topic based recommendations, including associated data structures, of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method, comprising:
determining, by a processor, a topic similarity score, a product similarity score and an operating system similarity score between an original post and each one of a plurality of previous posts;
determining, by the processor, an overall similarity score of the each one of the plurality of previous posts based on the topic similarity score, the product similarity score and the operating system similarity score; and
sending, by the processor, a recommendation based on the overall similarity score of the each one of the plurality of previous posts to a display device.

2. The method of claim 1, wherein the original post comprises a question about a product.

3. The method of claim 1, wherein the original post and the plurality of previous posts are within an online product discussion service.

4. The method of claim 1, wherein the determining the topic similarity score comprises:
creating, by the processor, a latent topic model using a machine learning algorithm; and
calculating, by the processor, a similarity between the original post and the each one of the plurality of previous posts based upon the latent topic model.

5. The method of claim 4, wherein the latent topic model comprises a plurality of different latent topic models and further comprising, performing a calculation of the similarity for each one of the plurality of different latent topic models and averaging the similarity for the each one of the plurality of different latent topic models.

6. The method of claim 1, wherein the determining the product similarity score and the operating system similarity score each comprises:
calculating, by the processor, a first similarity score based on a difference between a first string and a first length of a product or a operating system in the original post and a second string and a second length of the product or the operating system in one of the plurality of previous posts;
calculating, by the processor, a second similarity score based on the first string and the second string, the first length of the first string and the second length of the second string and a position of each element within the first string and the second string; and
combining, by the processor, the first similarity score and the second similarity score.

7. The method of claim 6, wherein the first similarity score is determined using a Levenshtein distance function.

8. The method of claim 6, wherein the second similarity score is determined using an ordered Jaccard function.

9. The method of claim 1, wherein the topic similarity score, the product similarity score and the operating system similarity score each has a different weight for calculating the overall similarity score.

10. An apparatus comprising:
a processor;
a storage coupled to the processor, wherein the storage is configured to store a plurality of previous posts;
a topic similarity module in communication with the processor, wherein the topic similarity module is configured to determine a topic similarity score between an original post and each one of the plurality of previous posts;
a product similarity module in communication with the processor, wherein the product similarly module is configured to determine a product similarity score between the original post and each one of the plurality of previous posts;
an operating system similarity module in communication with the processor, wherein the operating system similarity module is configured to determine an operating system similarity score between the original post and each one of the plurality of previous posts; and
a multi-aspect recommendations module in communication with the topic similarity module, the product similarity module, the operating system module and the processor, wherein the multi-aspect recommendations module is configured to determine an overall similarity score of the each one of the plurality of previous posts based on the on the topic similarity score, the product similarity score and the operating system similarity score and providing a recommendation based on the overall similarity score of the each one of the plurality of previous posts to a display device.

11. The apparatus of claim 10, further comprising:
a product recognition module in communication with the processor, wherein the product recognition module is configured to apply one or more recognition models to the original post to identify a topic, a product and an operating system contained in the original post.

12. The apparatus of claim 10, wherein processor is further configured to:
create a latent topic model using a machine learning algorithm; and
determine a similarity between the original post and the each one of the plurality of previous posts based upon the latent topic model.

13. The apparatus of claim 10, wherein product similarity module and the operating system similarity module are each further configured to:
determine a first similarity score based on a difference between a first string and a first length of a product or a operating system in the original post and a second string and a second length of the product or the operating system in one of the plurality of previous posts;
determine a second similarity score based on the first string and the second string, the first length of the first string and the second length of the second string and a position of each element within the first string and the second string; and
combine the first similarity score and the second similarity score.

14. The apparatus of claim 10, wherein the topic similarity score, the product similarity score and the operating system similarity score each has a different weight for calculating the overall similarity score.

15. A non-transitory machine-readable storage medium storing instructions executable by a processor, the machine-readable storage medium comprising:
instructions to determine a topic similarity score, a product similarity score and an operating system similarity score between an original post and each one of a plurality of previous posts;
instructions to determine an overall similarity score of the each one of the plurality of previous posts based on the topic similarity score, the product similarity score and the operating system similarity score; and
instructions to send a recommendation of a top K number of the plurality of previous posts based on the overall similarity score of the each one of the plurality of previous posts to a display device.
